(19) United States
(12) Patent Application Publication
(10) Pub. No.: US 2024/0254311 A1
(43) Pub. Date: Aug. 1, 2024

(54) STORAGE STABLE LATEX-SILICATE DISPERSION

(71) Applicant: Arkema Inc., King of Prussia, PA (US)

(72) Inventors: Lei YANG, King of Prussia, PA (US); Wenjun WU, King of Prussia, PA (US); Jeffrey A. SCHNEIDER, King of Prussia, PA (US)

(21) Appl. No.: 18/290,320

(22) PCT Filed: May 24, 2022
(86) PCT No.: PCT/US2022/030687

§ 371 Date: Nov. 13, 2023

Related U.S. Application Data
(60) Provisional application No. 63/193,657, filed on May 27, 2021.
(60) Provisional application No. 63/304,717, filed on Jan. 31, 2022.
(60) Provisional application No. 63/304,720, filed on Jan. 31, 2022.

(51) Int. Cl. C08K 3/34; C08K 5/5419; C09D 5/00; C09D 5/02; C09D 7/61; C09D 7/63; C09D 133/26

(52) U.S. Cl. CPC C08K 3/34; C08K 5/5419; C09D 5/002; C09D 5/024; C09D 7/61; C09D 7/63; C09D 133/26; C08K 2201/019

(57) ABSTRACT

A one-part composition includes by wt % of total weight of the composition: a) 5 to 70 wt % of at least one emulsified polymeric binder, the binder comprising one or more of (meth)acrylamide or derivatives thereof as a polymerized monomer; b) 1 to 55 wt % of at least one silicate; c) 0.01 to 10 wt % of at least one alkyl siliconate; d) water, and e) optional additives. The binder a) includes (meth)acrylamide or derivative thereof as a polymerized monomer and is in the form of emulsified polymeric particles having a volume average particle size of 50 nm-500 nm.

### FIELD OF THE INVENTION

The invention relates to one-part waterborne (aqueous) dispersions of latex, silicate and siliconate that are storage stable and adhere to cementitious/masonry substrates such as concrete substrates. The compositions are especially useful as primers or sealers on cementitious/masonry substrates.

### BACKGROUND OF THE INVENTION

Latex polymers have been widely used as waterborne organic binders in the coating industry. Typically, latex coatings adhere poorly to cementitious/masonry substrates, such as concrete, due to the complex surface properties of these substrates. Therefore, in order for latex coatings to adequately adhere to such surfaces, extensive surface preparation processes such as acid etching or sand blasting are used.

In contrast, alkali metal silicates have been widely used as waterborne inorganic binders that are particularly useful on concrete and other inorganic substrates. Silicate-based coating compositions typically have good adhesion to cementitious/masonry substrates (e.g., concrete substrates). Since latex coatings have desirable properties, such as flexibility, while the silicate containing coating compositions are able to provide a coating that adheres well to cementitious/masonry substrates (e.g., concrete substrates), a hybrid coating composition would be desirable and useful. However, such hybrid coating compositions including both silicate and latex typically are unstable in storage. This storage instability may be manifested by viscosity rise, coagulation, changes in particle size, and/or phase separation. Thus, previous such compositions have relied on either a two-part coating composition, in which the latex and the silicate components are kept separate and only combined immediately prior to use, or have included stabilizers, which may adversely affect coating performance. These stabilizers also may be costly and often do not contribute to the overall adhesion and durability of the resultant coating.
US 2019/0177558 discloses dialkylglucosamines as stabilizers for coating compositions that comprise both latex and silicate.
EP 3712216 discloses N,N,N′,N′-tetrakis (2-hydroxypropyl) hexane-1,6-diamine as a viscosity stabilizer in aqueous coating compositions containing silicate and at least one organic polymeric binder.
EP 2081998 (DE102006045853) discloses nitrogen-containing compounds having molecular weight from 120 to 10,000 Daltons combined with alkyl siliconates as viscosity stabilizers for coating compositions containing water, fillers and/or pigments as well as low levels of a binder.
EP 1297079 discloses a preservative-free emulsion paint containing 4-15 wt. % of a polymer dispersion; 10-55 wt. % of pigment and/or filler; a maximum of 2 wt. % of water glass as an additive; and water to make up to 100 wt. %.
WO 2020/180616 discloses a water-based coating composition containing a pigment, a polymeric dispersion and a hydrolysable silane. Optionally, 0.1 to 4 wt. %, of either or both of silicates and siliconates may be included.
WO 2020/002102 discloses an aqueous emulsion paint including a) 5 to 50% by weight of an aqueous polymer dispersion having a solids content in the range from 40 to 60% by weight; b) 0.1 to 10% by weight of alkali alkyl siliconate and/or water-soluble silicate; c) 20 to 70% by weight of inorganic fillers; d) 0 to 30% by weight of at least one inorganic pigment; and e) 0.1 to 10% by weight of conventional auxiliaries.
U.S. Pat. No. 9,228,094 discloses a composition for protecting a surface of an inorganic substrate, such as concrete, terrazzo, or ceramic tile, including a silicate (i.e., an alkali metal polysilicate or a colloidal silica), a siliconate (e.g., a metal siliconate, such as an alkali metal methyl siliconate, etc.), acrylic latex, a silane coupling agent, and a solvent, such as ethylene glycol monobutyl ether.
U.S. Pat. No. 10,322,485 discloses a method for treating a flooring surface. The method includes applying a composition that includes a silicate to the flooring surface and, while the composition is present on the surface, polishing or burnishing the surface. The silicate may be a lithium polysilicate and/or a colloidal silica.

Thus there is a need for one-part coating compositions that provides robust adhesion on cementitious/masonry substrates (e.g., concrete substrates), including minimally prepared substrates that were not subjected to extensive surface treatments, without the need of on-site mixing. There is also a need for a storage stable one-part system that does not include one or more intentionally added amine-containing viscosity stabilizers.

### SUMMARY

The inventors have discovered an aqueous one-part coating composition comprising, consisting of or consisting essentially of latex, silicate, and alkali siliconate which is surprisingly stable without the presence of additional stabilizers. This one-part composition showed long-time storage stability and the ability to adhere well as a primer or sealer on masonry/cementitious substrates, including but not limited to the substrates that were not subject to special surface treatments (e.g., acid etching and sandblasting). The primer, when used as a basecoat, also enables topcoat paints to consistently and suitably adhere to these substrates. Specifically, the composition utilizes a hybrid technology combining latex, silicate, and siliconate to yield a one-part aqueous composition that may be used to prepare primers or sealers, preferably clear primers or sealers, for masonry/cementitious substrates such as concrete, for example. Another advantageous property of the inventive latex-silicate-siliconate hybrid technology of the invention is its long-term storage stability for resins, primers, and/or sealers without the need to add/include viscosity stabilizers, as evidenced by minimal changes of particle size and viscosity after storing at 60° C. for 30 days. Since stability represents the most challenging issue associated with conventional organic-inorganic hybrid systems, the one-part latex-silicate-siliconate coating compositions of the present invention offer a unique advantage.

A one-part, storage-stable aqueous coating composition is provided. The composition is suitable for coating a substrate such as, but not limited to, concrete, cement, asphalt, masonry, metals, alloys of metals, metalloids, ceramic, porcelain, granite, silica, and combinations thereof. Importantly, the one-part composition is storage stable, and also provides a coating which, in some embodiments, adheres to substrates such as concrete and cement without a special surface preparation step.

The one-part aqueous composition comprises, consists essentially, or consists of, by wt % of the total weight of the composition:
a) 5 to 70 wt % of at least one emulsified polymeric binder;
b) 1 to 55 wt % of at least one silicate;
c) 0.01 to 10 wt % of at least one alkyl siliconate;
d) water; and
e) optional additives.

The binder comprises, consists essentially of, or consists of (meth)acrylamide or derivatives thereof as a polymerized monomer. The binder is in the form of emulsified polymeric particles having a volume average particle size of 50 nm-500 nm, preferably 65-400 nm, more preferably 80-300 nm.

### BRIEF DESCRIPTION OF THE DRAWINGS

FIG. 1 shows photographs taken with a cell phone of certain coating compositions after aging: (A) Example 1; (B) Comparative Example 1; (C) Example 3; (D) Comparative Example 3.

FIG. 2 are photographs taken with a cell phone showing adhesion performance of commercial paints on the unprimed concrete substrates in comparison with concrete substrates primed with Examples 3 and 4 of the invention.

### DETAILED DESCRIPTION

When a plurality of lower limits and a plurality of upper limits are provided herein with respect to ranges of a variable or ratio, the invention contemplates all ranges from any disclosed lower limit to any disclosed upper limit.

As used herein, the term “one-part” aqueous composition means that the compositions of the invention comprise both latex and the silicate components in a single unit/pot/system prior to use. “One-part” aqueous composition as used herein distinguishes the compositions of the present invention from “two-part” compositions where the latex and silicate components are kept in separate units/pots/systems such that they are only combined immediately prior to use.

One-part aqueous compositions in accordance with the present invention comprise, consist of or consist essentially of at least the following components, by wt % of the total weight of the aqueous composition: a) 5-70 wt % of at least one emulsified polymeric binder; b) 1-55 wt % of at least one silicate; c) 0.01-10 wt % of at least one alkyl siliconate; d) water; and e) optional additives. The total weight percent of components a) through e) may be balanced to 100 wt %. The binder a) is in the form of emulsified polymeric particles having a volume average particle size of 50 nm-500 nm, preferably 65-400 nm, more preferably 80-300 nm. The binder a) comprises (meth)acrylamide or derivatives thereof as a polymerized monomer.

According to another embodiment, the one-part aqueous composition may comprise, consist of or consist essentially of, a) 50-94.9 wt % of at least one emulsified polymeric binder that comprises (meth)acrylamide or derivatives thereof as a polymerized monomer; b) 5-50 wt % of at least one silicate; and c) 0.1-10 wt % of at least one alkyl siliconate; d) water; and e) optional additives, wherein the weight percent of each of a), b, and c) are based on the total dry weight of a)+b)+c).

The binder a) is in the form of emulsified polymeric particles having a volume average particle size of 50 nm-500 nm, preferably 65-400 nm, more preferably 80-300 nm.

### Binder a)

As used herein, “acrylamide” refers to a vinyl monomer containing amide group —C═O—NHR or ethylenically unsaturated carboxylic amide.

The binder a) comprises (meth)acrylamide or derivatives thereof as a polymerized monomer.

The one-part aqueous composition may comprise from about 5-70 wt %, from about 10-65 wt %, or from about 15-60 wt % of the weight of binder a) based on the total weight of the aqueous composition.

According to another embodiment, the one-part composition comprises, based on the total dry weight of the emulsified polymeric binder a), silicate b), and alkyl siliconate c) of the one-part composition, 50-94.9 wt % of the at least one emulsified polymeric binder a). According to certain embodiments, the composition may comprise from about 60-94.9 wt %, from about 65-90, or from about 70-85 wt %, based on the total dry weight of the emulsified polymeric binder a), silicate b), and alkyl siliconate c) (i.e., exclusive of the water) of the aqueous one-part composition.

The binder a) comprises, as a polymerized monomer, (meth)acrylamide and/or derivatives thereof. Suitable (meth)acrylamide derivatives may include, but are not limited to N-(hydroxymethyl)acrylamide, N-(hydroxyethyl) acrylamide, 2-hydroxypropyl methacrylamide, methacrylamide poly(ethylene glycol) amine hydrochloride, N-tris(hydroxymethyl)methylacrylamide, (4-hydroxyphenyl)methacrylamide, 2-aminoethylmethacrylamide hydrochloride, N-phenylacrylamide, 2-acrylamido-2-methylpropane sulfonic acid and its salts, and mixtures thereof. According to certain embodiments, the (meth)acrylamide and/or derivatives thereof is present at from about 0.01-10 wt % of the dry weight of the binder a). According to some embodiments, the (meth)acrylamide and/or derivatives thereof is present at from about 0.01 to 10 wt %, from about 0.05-5 wt %, from about 0.05-3 wt % or from about 0.1 to 2 wt % of the dry weight of the binder a).

The binder a) may further comprise other free-radical polymerizable monomers in addition to the above-mentioned (meth)acrylamide and/or derivatives thereof. The monomers in addition to the (meth)acrylamide and/or derivatives thereof are not particularly limited. For example, the binder may further comprise styrene or derivatives thereof, alkyl(meth)acrylates, and/or carboxylic acid monomers, such as (meth)acrylic acid, itaconic acid, and maleic acid. For example, the binder a) may further comprise methyl methacrylate, butyl acrylate and/or acrylic acid as polymerized monomers. According to an embodiment, the binder a) may comprise, consist of or consist essentially of about 0-90 wt % styrene or derivatives thereof, about 10-99.8 wt % alkyl (meth)acrylate, about 0 to 10 wt % (meth)acrylic acid and about 0.01 to 10 wt % (meth)acrylamide as polymerized monomers based on the total dry weight of the binder a). The binder a) may comprise, consist of, or consist essentially of about 0-90 wt % styrene or a derivative thereof, about 10-99.8 wt % alkyl (meth)acrylate, about 0.1 to 5 wt % (meth)acrylic acid and about 0.05 to 5 wt % (meth)acrylamide as polymerized monomers based on the total dry weight of the binder a). The binder a) may comprise, consist of or consist essentially of about 0-85 wt % styrene or derivatives thereof, about 15-99.7 wt % alkyl (meth)acrylate, about 0.25 to 3 wt % (meth)acrylic acid and about 0.05 to 3 wt % (meth)acrylamide as polymerized monomers based on the total dry weight of the binder a). The binder a) may comprise, consist of or consist essentially of about 0-80 wt % styrene or derivatives thereof, about 20-99.4 wt % alkyl (meth)acrylate, about 0.5 to 2 wt % (meth)acrylic acid and about 0.1 to 2 wt % (meth)acrylamide as polymerized monomers based on the total dry weight of the binder a).

According to one embodiment, the binder a) may comprise, consist of or consist essentially of about 0-90 wt % styrene or derivatives thereof, about 10-99.8 wt % alkyl (meth)acrylate, about 0 to 10 wt % (meth)acrylic acid and about 0.01 to 10 wt % (meth)acrylamide or derivatives thereof as polymerized monomers based on the total dry weight of the binder a). The binder a) may comprise, consist of or consist essentially of about 0-90 wt % styrene, about 10-99.9 wt % alkyl (meth)acrylate, about, 0.1 to 5 wt % (meth)acrylic acid and about 0.05 to 5 wt % (meth)acrylamide or derivatives thereof as polymerized monomers based on the total dry weight of the binder a). The binder a) may comprise, consist of or consist essentially of about 0-85 wt % styrene, 15-99.7 wt % alkyl (meth)acrylate, about 0.25 to 3 wt % (meth)acrylic acid and about 0.05 to 3 wt % (meth)acrylamide or derivatives thereof as polymerized monomers based on the total dry weight of the binder a). The binder a) may comprise, consist of or consist essentially of 0-80 wt % styrene, 20-99.4 wt % alkyl (meth)acrylate, 0.5 to 2 wt % (meth)acrylic acid and 0.1 to 2 wt % (meth)acrylamide or derivatives thereof as polymerized monomers based on the total dry weight of the binder a).

Other suitable monomers in addition to (meth)acrylamide or derivatives thereof may be included in the binder a) at levels from about 0.1 to 99.5 wt %, or at about 0.2 wt %, 0.3 wt %, 0.5 wt %, 0.6 wt %, 0.7 wt %, 0.8 wt %, 0.9 wt %, 1 wt %, 3 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 90 wt %, 95 wt %, 98 wt %, or 99 wt %, based on the dry weight of binder a). These suitable monomers include styrene and derivatives thereof, alkyl esters of (meth) acrylic acid and carboxylic acid monomers, for example. Non-limiting examples include methyl (meth)acrylate, ethyl (meth)acrylate, butyl (meth)acrylate, cyclohexyl (meth)acrylate, allyl methacrylate, 2-ethylhexyl acrylate; various carboxylic acids such as methacrylic acid, acrylic acid, itaconic acid, etc., various esters of versatic acid, iso-octyl methacrylate and iso-octyl acrylate, lauryl acrylate and lauryl methacrylate, stearyl acrylate and stearyl methacrylate, isobornyl acrylate and isobornyl methacrylate, methoxy ethyl acrylate and methoxy methacrylate, 2-ethoxy ethyl acrylate and 2-ethoxy methacrylate, and methacrylate monomers.

Also suitable as optional monomers are acrylonitrile; vinyl cyanides; vinylpyrrolidone; polypropylene glycol mono(meth)acrylate or polyethylene glycol mono(meth)acrylate; phosphorous-based monomers including but are not limited to phosphoalkyl (meth)acrylates or acrylates, phospho alkyl (meth)acrylamides or acrylamides, phosphoalkyl crotonates, phosphoalkyl maleates, phosphoalkyl fumarates, phosphodialkyl (meth)acrylates, phosphodialkyl crotonates, vinyl phosphates and (meth)allyl phosphate, phosphate esters of polypropylene glycol mono(meth)acrylate or polyethylene glycol mono(meth)acrylate, polyoxyethylene allyl ether phosphate, vinyl phosphonic acid. Suitable sulfur-based monomers include, but are not limited to, vinyl- and allyl-sulfonic or sulfuric acids, sulfoethyl (meth)acrylate, aryl-sulfonic or sulfuric acids, (meth)acrylamidoethane-sulfonic or sulfuric acids, methacrylamido-2-methyl propane-sulfonic or sulfuric acids, and the alkali metal salts of sulfonic and sulfuric acids. Suitable optional silane co-monomers include, but are not limited to methacryloxypropyl trimethoxysilane, methacryloxypropyl triethoxysilane, methacryloxypropyl tripropoxysilane, vinyltriacetoxysilane, vinyltrimethoxysilane, and vinyltriethoxysilane. The more preferred silane co-monomers are methacryloxypropyl trimethoxysilane and vinyltrimethoxysilane. These optional monomers, if present, may be included in the binder a) at levels from about 0.1 to 99.5 wt %, or at about 0.2 wt %, 0.3 wt %, 0.5 wt %, 0.6 wt %, 0.7 wt %, 0.8 wt %, 0.9 wt %, 1 wt %, 3 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 90 wt %, 95 wt %, or 99 wt %, based on the dry weight of binder a).

Crosslinkable co-monomers may also optionally be present in polymeric binder a). These crosslinkable co-monomers may be of two different types. The first type is crosslinkable co-monomers that include two or more sites of ethylenic unsaturation such that the crosslinks are formed during polymerization of the polymeric binder a). The second type of crosslinkable co-monomer are those that include, in addition to an ethylenic unsaturation ((meth)acrylate, allyl or vinyl functional groups), at least one moiety that is capable of reacting with a separate crosslinking compound that may be included in the one-part aqueous composition to form a crosslink.

Suitable crosslinkable co-monomers with two or more sites of ethylenic unsaturation include, but are not limited to, ethylene glycol dimethacrylate, diethylene glycol dimethacrylate, trimethylolpropane trimethacrylate, 1,3-butyleneglycol dimethacrylate, and 1,4-butyleneglycol dimethacrylate, hexanediol dimethacrylate, divinyl benzene, diallyl phthalate.

Crosslinkable co-monomers that are capable of reacting with a separate crosslinking agent that may be included in the one-part aqueous composition may be selected from, for example, acetoacetate co-monomers containing (meth)acrylate, allyl or vinyl functional groups including but not limited to acetoacetate moieties such as: 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate and combinations thereof. Also suitable are co-monomers containing a keto group such as diacetone acrylamide. The more preferred crosslinkable monomers are acetoacetoxyethyl methacrylate and diacetone acrylamide. Water soluble crosslinking agents that can react with certain moieties of these second type of crosslinkable co-monomers may also optionally be included in the one-part aqueous composition. These water soluble crosslinking agents effect post crosslinking during film formation and drying by reacting with the crosslinkable moieties on the second type of crosslinkable co-monomers. For example such crosslinking agents containing at least two hydrazine and/or hydrazide groups may be included in certain embodiments of the one-part aqueous composition. Preferred such separate crosslinking agents are water soluble. Non-limiting examples include oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide and/or itaconic acid dihydrazide. Adipic acid dihydrazide (ADH) is a preferred water-soluble cross-linking agent for use in the compositions herein, especially those produced from monomer compositions containing diacetone acrylamide (DAAM). Other suitable water-soluble cross-linking agents are compounds which contain at least two amine functional moieties such as ethylene diamine and hexamethylene diamine. Such cross-linking agents are preferred in combination with polymers comprising 1,3-dicarbonyl groups as the crosslinkable moiety, such as acetoacetoxyethyl methacrylate (AAEM). These separate crosslinking agents may be present in the one-part aqueous composition at from 0.01 to 10 wt % of the aqueous one-part composition. For example, the separate crosslinking agents may be present at from 0.1-8 wt %, or from 1 to 5 wt % based on the total weight of the one-part aqueous composition.

These optional crosslinking co-monomers of either type, if present, may be included in the binder a) at levels from about 0.1 to 50 wt %, or at about 0.2 wt %, 0.3 wt %, 0.5 wt %, 0.6 wt %, 0.7 wt %, 0.8 wt %, 0.9 wt %, 1 wt %, 3 wt %, 5 wt %, 10 wt %, 15 wt %, 20 wt %, 25 wt %, 30 wt %, 35 wt %, 40 wt %, 45 wt %, or 50 wt %, based on the dry weight of binder a).

Emulsion polymers and monomers useful to prepare polymeric emulsions or dispersions are known in the art (see, e.g., “Emulsion Polymerization: Theory and Practice” by D. C. Blackley published by Wiley in 1975, “Emulsion Polymerization” by F. A. Bovey et al. published by Interscience Publishers in 1965, and “Emulsion Polymerization and Emulsion Polymers” by P. A. Lovell et al. published by Wiley Science in 1997).

The emulsion polymers might further comprise non-polymerizable additives. The non-polymerizable additives can be added during the polymerization or after polymerization. Non-limiting examples of suitable non-polymerizable additives include silanes, epoxysilanes, oligomeric epoxysilanes, aminosilanes, coalescents, rheology control additives, additional polymers, surfactants, plasticizers, defoamers, thickeners, biocides, solvents, rheology modifiers, wetting or spreading agents, conductive additives, thermal insulating fillers, adhesion promoters, anti-blocking agents, anti-cratering agents or anti-crawling agents, corrosion inhibitors, anti-static agents, flame retardants, optical brighteners, UV absorbers or other light stabilizers, chelating agents, cross-linking agents, flattening agents, flocculants, humectants, insecticides, lubricants, odorants, oils, waxes or anti-slip aids, soil repellants, and/or stain resistant agents

### Silicate b)

As used herein, “silicate” refers to any inorganic salt silicate, including preferably compounds having the formula M₂ₓSi_{y}O_{2y+x}, M being alkali metal ions such as Li+, Na+, K+Rb+, or ammonium ion NH₄⁺. The one-part aqueous composition comprises about 2-50 wt % of the at least one silicate b), based on the total dry weight of the one-part composition. For example, the one-part composition may comprise from about 5-50 wt %, from about 8-40 wt %, or from about 10-35 wt % of the at least one silicate b), based on the total dry weight of a) at least polymeric binder, b) at least one silicate, and c) at least one alkyl siliconate of the composition, i.e., not including the water.

The one-part aqueous composition comprises from about 1-55 wt % of at least one silicate based on the total weight of the one-part aqueous composition, i.e., including the water. For example, the one-part aqueous composition may comprise from about 1-50 wt %, from about 1.5-45 wt %, or from about 2-40 wt % of the total weight of the aqueous composition.

In one embodiment, the at least one silicate b) may comprise, consist of or consist essentially of at least one of sodium silicate, potassium silicate, lithium silicate, rubidium silicate, ammonium silicate, orthosilicates, inorganic silicate salts, or a mixture thereof. Potassium silicate, sodium silicate and lithium silicate are preferred. More preferred are potassium silicate and lithium silicate.

### Siliconate c)

The alkyl siliconate c) may be present in the one-part composition at from about 0.1-10 wt % based on the total dry weight of the at least one emulsified polymeric binder, at least one silicate, and at least one alkyl siliconate of the composition. For example, the alkyl siliconate may be present at from about 0.5-8 wt %, or from 1-5 wt %, based on the total dry weight of components a), b), and c) of the one-part composition.

The one-part aqueous composition may comprise, consist of or consist essentially of from about 0.01 to 10 wt % of at least one alkyl siliconate, based on the total weight of the aqueous composition. The alkyl siliconate may be present in the one-part composition at from about 0.05-8 wt %, from 0.1-6 wt %, or from 0.2 to 5 wt %, based on the total weight of the aqueous composition.

Preferably, the at least one alkyl siliconate c) is defined according to Formula (I):

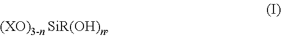

where X is an alkali metal; n is 0, 1, or 2; and R is an alkyl or aryl radical.

The metal X comprises at least one of sodium, potassium, lithium, rubidium, cesium, or combinations thereof. The preferred metal ions are potassium, lithium and sodium. More preferred is potassium.

The R comprises a C1-C8 alkyl group or an aryl group. The R may comprise methyl, ethyl, n-propyl, iso-propyl, n-butyl, iso-butyl, tert-butyl, n-pentyl, iso-pentyl, tert-pentyl, neopentyl, phenyl, aryl, or cyclohexyl. The preferred alkyl group is methyl. According to one embodiment, R is methyl, X is potassium and n is 0.

### Water d)

The one-part storage stable aqueous composition may comprise water to make the total percentage of a) binder, b) silicate, c) siliconate, d) water, and e) optional additives equal to 100 wt %. According to certain embodiments, the storage-stable composition may be diluted with more water prior to use. For example, about 5 wt %, 10 wt %, 15 wt %, 20 wt %, 25 wt %, 50 wt %, 60 wt %, 70 wt %, 80 wt %, 90 wt %, 100 wt % or 200 wt % of additional water may be added to the aqueous storage stable one-part composition prior to applying the composition to a substrate, in some embodiments to form a primer or sealer.

### Viscosity Stabilizers

In an embodiment, the composition does not include any intentionally added viscosity stabilizers comprising an amine. Such viscosity stabilizers may be specifically designed for coating compositions that contain latex and silicate such as intentionally added amine intended to render the composition stable. The one-part composition may include less than 1 wt %, less than 0.5 wt %, less than 0.1 wt %, less than 0.05 wt % of each of such intentionally added viscosity stabilizers comprising an amine, i.e. if a mixture of such viscosity stabilizers is added, each component in the mixture does not exceed the above limitations amines. According the another embodiment, the total of the viscosity stabilizers comprising an amine may not exceed the above limits. Such viscosity stabilizers comprising an amine which may be excluded from this invention include those according to the formula:

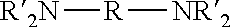

where R may be (CH₂)ₙ with n=1-8 or R may be (CH₂)ₙ—X—CH₂) with X=N—R′; and
where R′ may be CH₃; —CH₂—CH₃; CH₂—CH₂—OH; —CH₂—CH(OH)—CH₃, which may be identical or different from each other.
N,N,N′,N′-tetrakis (2-hydroxypropyl) hexane-1,6-diamine is exemplary.

Amines of the following formula are also not present or present at the low levels disclosed above:

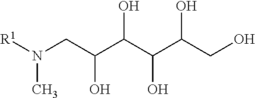

where R¹ is C1-C4 alkyl, CH₂CH₂OH or CH₂CH(CH₃)OH.

Also not present or present at the very low levels disclosed above are amines and/or organic quaternary ammonium compounds having a weight-average molecular weight in the range of 120 and 10,000.

According to another embodiment, the one-part composition may not include any intentionally added emulsifier or includes very little intentionally added emulsifier. Non-limiting examples of emulsifiers that are not present or that are present at less than 1 wt %, less than 0.5 wt %, less than 0.1 wt %, less than 0.05 wt %, less than 0.03 wt % in the one-part composition may include ionic, anionic and cationic surfactants. Examples of nonionic emulsifiers include tert-octylphenoxyethylpoly-ethoxyethanol, dodecyloxypolyethoxyethanol, tridecyloxypolyethoxyethanol, nonylphenoxyethyl-polyethoxyethanol, polyethylene glycol 2000 monooleate, ethoxylated castor oil, fluorinated alkyl esters and alkoxylates, polyoxyethylene sorbitan monolaurate, sucrose monococoate, di(2-butyl)phenoxypolyethoxyethanol, hydroxyethylcellulosepolybutyl acrylate graft copolymer, dimethyl silicone polyalkylene oxide graft copolymer, poly(ethylene oxide)poly(butyl acrylate) block copolymer, block copolymers of propylene oxide and ethylene oxide, 2,4,7,9-tetramethyl-5-decyne-4,7-diol ethoxylated with 30 moles of ethylene oxide, N-polyoxyethylenelauramide, N lauryl-N-polyoxyethyleneamine and polyethylene glycol dodecyl thioether. Examples of ionic (anionic or cationic) emulsifiers include sodium lauryl sulfate, sodium lauryl ether sulfate, sodium dodecylbenzenesulfonate, potassium stearate, sodium dioctyl sulfosuccinate, sodium dodecyldiphenyloxide disulfonate, nonylphenoxyethylpolyethoxyethyl sulfate ammonium salt, sodium styrene sulfonate, sodium dodecyl allyl sulfosuccinate, palmitic acid, palmitoleic acid, stearic acid, oleic acid, linoleic acid, linolenic acid, mixtures of fatty acids (e.g., linseed oil fatty acid), sodium or ammonium salts of phosphate esters of ethoxylated nonylphenol, sodium octoxynol-3-sulfonate, sodium cocoyl sarcocinate, sodium 1-alkoxy-2-hydroxypropyl sulfonate, sodium α-olefin (C14-C16)sulfonate, sulfates of hydroxyalkanols, tetrasodium N-(1,2-dicarboxy ethyl)-N-octadecylsulfosuccinamate, disodium N-octadecylsulfosuccinamate, disodium alkylamido polyethoxy sulfosuccinate, disodium ethoxylated nonylphenol half ester of sulfosuccinic acid and the sodium salt of tert-octylphenoxyethoxypolyethoxyethyl sulfate.

### Optional Additives e)

The one-part composition may further comprise at least one optional additive. Optional additives as used herein excludes (i) a stabilizer, (ii) at least one of the amines listed above, (iii) an amine having a weight-average molecular weight in the range of 120 and 10,000, and/or (iv) an organic quaternary ammonium compound having a weight-average molecular weight in the range of 120 and 10,000.

Non-limiting examples of suitable additives included within this invention are low molecular weight alcohol amines such as ammonium hydroxide to neutralize latex, coalescents, leveling agents, pigments, tints, emulsifiers, rheology control additives, additional polymers, colorants, fillers, dispersants or surfactants, plasticizers, defoamers, thickeners, biocides, solvents, rheology modifiers, wetting or spreading agents, conductive additives, thermal insulating fillers, adhesion promoters, silane additives, anti-blocking agents, anti-cratering agents or anti-crawling agents, corrosion inhibitors, anti-static agents, flame retardants, optical brighteners, UV absorbers or other light stabilizers, chelating agents, cross-linking agents, flattening agents, flocculants, humectants, insecticides, lubricants, odorants, oils, waxes or anti-slip aids, soil repellants, and/or stain resistant agents. The additives can be added at any stage of the preparation of the one-part composition. For example, the additives can be added during the preparation of binder a). The additives can also be added after binder a), silicate b), and siliconate c) have been mixed together.

According to an embodiment, the one-part composition is used as a primer or sealer. Accordingly, the one-part composition of the invention does not contain any or contains very little pigment and/or filler. For example, the one-part composition may include less than 5 wt %, less than 3 wt %, less than 1 wt %, less than 0.5 wt %, less than 0.1 wt %, less than 0.05 wt % or less than 0.03 wt %, or 0 wt %, of a filler or pigment. This means that for certain embodiments, when applied to a substrate and dried, the dried one-part composition may be substantially colorless, or substantially clear meaning that the substrate may be seen through the dried coating layer by the naked eye.

According to an embodiment, the one-part composition is free or substantially free of biocidal agents, including less than 500 ppm (by weight) or less than 250 ppm biocidal agents.

According to an embodiment, the one-part composition has a pH of from 10 to 13, preferably from 10.2 to 12.8, more preferably from 10.5 to 12.5.

### Applications

A coated substrate, including the present one-part composition as a dried layer on at least one surface of the substrate is provided. The substrate may be at least one of concrete, cement, asphalt, masonry, metals, alloys of metals, metalloids, ceramic, porcelain, granite, silica, or combinations thereof. According to an embodiment, the substrate is not subjected to special surface preparation prior to applying the inventive one-part composition. By special surface preparation, it is meant surface preparations such as sand-blasting, power washing with high pressure water, acid etching, or other forms of surface preparation as are known and used in the art to improve adhesion of a coating or primer or sealer to a surface, in particular a concrete surface or inorganic substrate surface.

A primer or sealer including the inventive one-part composition, optional additives, and at least 5 wt % of additional water is provided. According to certain embodiments, 10 wt %, 15 wt %, 20 wt %, 25 wt %, 30 wt %, 50 wt %, 75 wt %, 100 wt % or 200 wt % of additional water by total weight of the one-part composition may be added to the inventive one-part aqueous composition to form a primer or sealer. According to certain embodiments, the primer or sealers may further comprise optional additives. Non-limiting examples of suitable additives included within this invention are low molecular weight alcohol amines such as ammonium hydroxide to neutralize latex, coalescents, leveling agents, tints, emulsifiers, rheology control additives, additional polymers, colorants, dispersants or surfactants, plasticizers, defoamers, thickeners, biocides, solvents, rheology modifiers, wetting or spreading agents, conductive additives, thermal insulating fillers, adhesion promoters, silane additives, anti-blocking agents, anti-cratering agents or anti-crawling agents, corrosion inhibitors, anti-static agents, flame retardants, optical brighteners, UV absorbers or other light stabilizers, chelating agents, cross-linking agents, flattening agents, flocculants, humectants, insecticides, lubricants, odorants, oils, waxes or anti-slip aids, soil repellants, and/or stain resistant agents. According to certain embodiments, the primer or sealer does not include pigment and/or fillers and accordingly provides a clear coating after drying.

### EXAMPLES

### Methods

Viscosity was measured with a DVII+ Brookfield viscometer with #3 spindle at 60 rpm.

Heat aging was done by storing samples at 60° ° C. for 30 days in closed cans. The occurrence of instability including phase separation and sedimentation was monitored by visual examination of the samples. The change in particle size or viscosity was actually measured as described herein. The results are presented as: “Pass” if there is no occurrence of instability and “Fail” if there is occurrence of instability.

pH was measured with a bench or portable pH meter, available from Cole-Parmer.

Adhesion performance was measured using a crosshatch tape pull off test based on ASTM D 3359B. For dry adhesion test, the dried coating films were crosshatched using a sharp blade to produce a 5×5 grid, followed by applying adhesion tape to each of the films. To ensure good contact with films, tape was rubbed firmly with a tongue depressor. The tape was then immediately pulled off with a constant force at a 180° angle. For wet adhesion test, dried coating films were prepared and cross-hatched following the same procedure described above for the dry adhesion test, except that a piece of paper towel was wet by water droplets and then applied onto the crosshatched area. Afterwards, the wet paper towel was removed and the surface of the dried coating film was blot dried. The adhesion test was performed using the same procedure described above for the dry adhesion test.

Volume average particle size was measured by dynamic light scattering using a Nanotrac UPA150 from Microtrac.

The reported glass transition temperatures Tg were calculated using the Fox equation.

The minimum film formation temperature was measured according to ASTM D2354-10(2018).

### Examples 1-4, Comparative Examples 1 and 2

### Latex 1 Preparation:

590.2 parts of deionized water and 4.6 parts of Encor® 9710 seed (40% active) latexes (Arkema) were charged into a reactor equipped with a stirrer, reflux condensers, thermocouples, and stainless steel feed lines. After the reactor was heated to 90° C., 0.5 parts of ammonium persulfate in 9.7 parts of water were added into the reactor. The monomer mixture consisting of 511.7 parts of butyl acrylate (BA), 496.4 parts of styrene (STY), 10.3 parts of acrylic acid (AA) was then fed continuously to the reactor over 200 minutes. During the monomer feed, a solution of 11.4 parts of Dowfax® 2Al (anionic surfactant) (45%) and 17.0 parts of acrylamide (30%) in 90.4 parts of water was fed into the reactor over 180 minutes separately. In addition, 4.6 parts of ammonium persulfate in 73.4 parts of water were fed into the reactor over 210 min separately. At the end of monomer feed, 0.2 parts of DREWPLUS® L-131 (foam control agent, Ashland) in 34.4 parts of water was added into the reactor. To reduce the residual monomer concentrations, 6.1 parts of tertiary-butyl hydroperoxide (tBHP, 70% active) and 4.2 parts of sodium hydroxymethane sulfinic acid were fed over 45 minutes at 80° C. The final pH of the latex was adjusted to 9 using ammonium hydroxide. The final latex has solids content of 51%, average particle size of 215 nm and Brookfield viscosity below 500 centipoise. The minimum film formation temperature (“MFFT”) of Latex 1 was 16° C. The MFFT of the latex was analyzed on a rectangular temperature gradient bar. The MFFT was determined at the point where the latex formed a clear and uncracked dry film.

### Latex 2 Preparation:

Latex 2 was prepared using 701.7 parts of butyl acrylate, 306.4 parts of styrene, 10.3 parts of acrylic acid, and 17.0 parts of acrylamide while maintaining other parameters the same in the synthesis. The final latex has solids content of 51%, average particle size of 215 nm and Brookfield viscosity below 500 centipoise. The minimum film formation temperature of Latex 2 was 0° C.

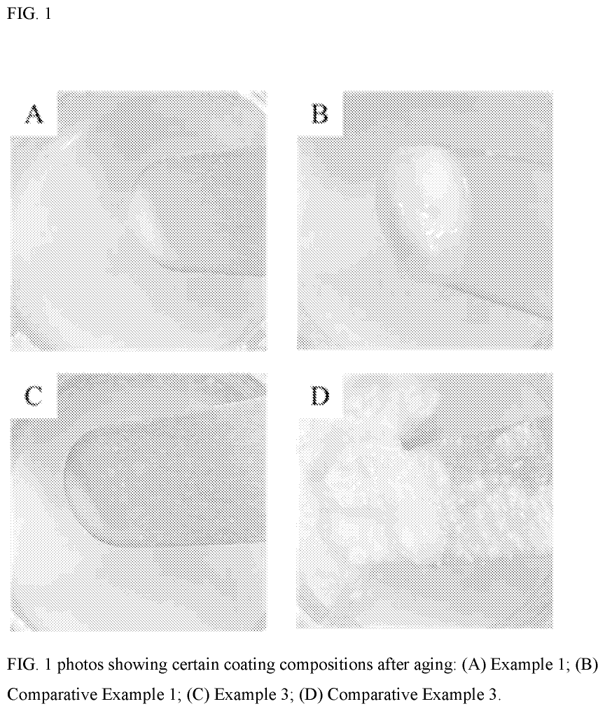

A series of latex-silicate hybrids were prepared according to Table 1, and the active content of each component was provided in Table 2. Specifically, inventive Example 1 and Example 2 were prepared by blending latex, potassium silicate (KASIL® 1, PQ corporation, active content of 29%), with potassium methyl siliconate (Silres® BS16, Wacker, active content of 34%). Both latex and silicate had active percentages greater than 5 wt % (Table 2). The comparative examples (Comparative Example 1 and Comparative Example 2) were prepared by blending latex and potassium silicate without the presence of potassium methyl siliconate. The storage stability of these compositions was evaluated by testing their heat age stability. Specifically, the compositions were stored under 60° C. for 30 days by monitoring the occurrence of phase separation, sediments, and change in particle size or viscosity. As shown in Table 1, both Example 1 and Example 2 showed exceptional storage stability, while significant instability (e.g., coagulation and sedimentation) was observed for both Comparative Example 1 and Comparative Example 2. Table 2 shows the components of Table 1, but in dry weight percents of each component, based on the total weight of the composition including water. FIG. 1 shows the difference in appearance of the representative inventive Example and comparative Examples after heat aging for 4 weeks. The inventive Example 1 (FIG. 1A) did not show any phase separation, viscosity change, or measurable particle size change, while the comparative Example 1 (FIG. 1B) showed sedimentation that were not dispersible after heat aging for 4 weeks.

TABLE 1
Heat aging stability of inventive and comparative formulations

| | | Compar- | | Compar- |
|---|---|---|---|---|
| | | ative | | ative |
| | Example 1 | Example 1 | Example 2 | Example 2 |
| | Weight | Weight | Weight | Weight |
| Component | (gram) | (gram) | (gram) | (gram) |
| Latex 1 | 137.5 | 140.0 | 0.0 | 0.0 |
| (51% solids) | | | | |
| Latex 2 | 0.0 | 0.0 | 137.5 | 140.0 |
| (51% solids) | | | | |
| potassium silicate (29% | 57.5 | 60.0 | 57.5 | 60.0 |
| solids) | | | | |
| potassium methyl | 5.0 | 0.0 | 5.0 | 0.0 |
| siliconate (34% solids) | | | | |
| Water | 20.0 | 20.0 | 20.0 | 20.0 |
| Total | 220.0 | 220.0 | 220.0 | 220.0 |
| Heat age stability (no | Passed | Failed | Passed | Failed |
| phase separation/ | | | | |
| sedimentation/change | | | | |
| in particle size | | | | |
| and viscosity) | | | | |

TABLE 2
Heat aging stability of inventive and comparative formulations

| | | Compar- | | Compar- |
|---|---|---|---|---|
| | | ative | | ative |
| | Example 1 | Example 1 | Example 2 | Example 2 |
| | Active | Active | Active | Active |
| Component | Wt % | Wt % | Wt % | Wt % |
| Latex 1 | 32.0 | 32.5 | 0.0 | 0.0 |
| (51% solids) | | | | |
| Latex 2 | 0.0 | 0.0 | 32.0 | 32.5 |
| (51% solids) | | | | |
| potassium silicate (29% | 7.6 | 7.9 | 7.6 | 7.9 |
| solids) | | | | |
| potassium methyl | 5.0 | 0.0 | 5.0 | 0.0 |
| siliconate (34% solids) | | | | |
| Water | 59.6 | 59.6 | 59.6 | 59.6 |
| Total % | 100.0 | 100.0 | 100.0 | 100.0 |
| Heat age stability (no | Passed | Failed | Passed | Failed |
| phase separation/ | | | | |
| sedimentation/change | | | | |
| in particle size | | | | |
| and viscosity) | | | | |

Example 1, Comparative Example 1, Example 2 above, and Comparative Example 2 were formulated into a primer formulation shown as Example 3, Comparative Example 3, Example 4, and Comparative Example 4, respectively and shown in Table 3. Both Example 3 and Example 4 showed good storage stability as evidenced by their capability of passing heat-age stability test (Table 3) with no visible coagulum formation and the essentially no change in particle size (217 nm) after heat aging. These may be compared to Comparative Examples 3 and 4, which showed coagulation and phase separation. FIG. 1 shows photographs (taken with a cell phone) of the representative primer coating compositions after heat aging for 4 weeks. Example 3 (FIG. 1C) did not show any phase separation, viscosity change, or measurable particle size change. In comparison, Comparative Example 3 (FIG. 1D) showed significant phase separation and coagulum that were not dispersible after heat aging for 4 weeks.

TABLE 3
Heat aging stability of inventive and
comparative primer compositions.

| | Example | | Example | |
|---|---|---|---|---|
| | 3 (of the | Comparative | 4 (of the | Comparative |
| | invention) | Example 3 | invention) | Example 4 |
| Component | Weight (gm) | Weight (gm) | Weight (gm) | Weight (gm) |
| Example 1 | 49.2 | 0.0 | 0.0 | 0.0 |
| Example 2 | 0.0 | 0.0 | 50.0 | 0.0 |
| Comparative | 0.0 | 49.2 | 0.0 | 0.0 |
| Example 1 | | | | |
| Comparative | 0.0 | 0.0 | 0.0 | 50.0 |
| Example 2 | | | | |
| Water | 49.2 | 49.2 | 50.0 | 50.0 |
| Texanol ™ | 1.6 | 1.6 | 0.0 | 0.0 |
| (Eastman, | | | | |
| coalescent) | | | | |
| Total | 100.0 | 100.0 | 100.0 | 100.0 |
| pH | 11.3 | 11.3 | 11.3 | 11.3 |
| Wt % Solids | 19.7 | 19.7 | 20.0 | 20.0 |
| Brookfield | <100 | <100 | <100 | <100 |
| Viscosity | | | | |
| (centipoise at | | | | |
| 25° C.) | | | | |
| Heat age | Passed | Failed | Passed | Failed |
| stability | | | | |

TABLE 4
Compositions and adhesion performance of inventive
primer compositions on cement substrates.

| | Example 3 (of | Example 4 (of |
|---|---|---|
| | the invention) | the inventions) |
| | Active Weight | Active Weight |
| Component | percentage | percentage |
| Latex 1 | 15.7 | 0.0 |
| Latex 2 | 0.0 | 16.0 |
| Potassium Silicate | 3.7 | 3.8 |
| Potassium methyl siliconate | 0.4 | 0.4 |
| Water | 78.6 | 79.8 |
| Texanol ™ (Eastman, | | |
| coalescent) | 1.6 | 0.0 |
| Total wt % | 100.0 | 100.0 |
| pH | 11.3 | 11.3 |
| Wt % Solids | 19.7 | 20.0 |
| Brookfield Viscosity | <100 | <100 |
| (centipoise at 25° C.) | | |
| Heat age stability | Passed | Passed |

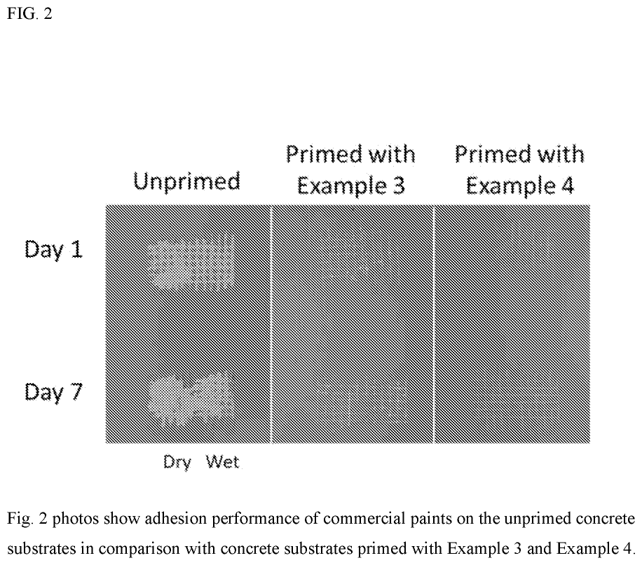

Table 4 summarizes the active percentage of each component in Example 3 and Example 4. Example 3 and Example 4 were useful as primers which adhered well to concrete substrates that did not subject to acid etching or sandblasting and then permitted a successful subsequent application of a paint over the inventive primer. Specifically, Example 3 or Example 4 primer was applied to a concrete substrate at approximately 1 gallon/400 square feet and allowed to dry for 4 hours, followed by applying commercial paints as topcoats. The adhesion performance was tested using crosshatch tape pull off test according to ASTM D 3359 method B after 1 day and 7 days of drying of topcoats, respectively. FIG. 2 shows the adhesion performance of commercial paints on the unprimed concrete substrates in comparison with concrete substrates primed with Example 3 and Example 4. Once primed the concrete substrates with Example 3 or Example 4, the adhesion performance of commercial paints was significantly improved. In addition, after heat aging Example 3 or Example 4 for 4 weeks, the good adhesion performance provided by Example 3 or Example 4 remained almost unchanged, thus demonstrating their good storage stability.

### Example 5, 6, and 7

These additional Examples were prepared according to the procedure of Example 1. Example 5 was made with the same composition as in Example 1, but with methyl methacrylate replacing styrene in Latex 1 as a polymerized monomer therein. Example 6 was made with the same composition as Example 1, but changing the volume average particle size of Latex 1 to 140 nm by increasing the amount of Encor® 9710 seed to 15.7 parts and Dowfax® 2Al to 45.2 parts. Example 7 was made with the same composition as in Example 1, but with 2-acrylamido-2-methylpropane sulfonic acid replacing acrylamide in Latex 1 as a polymerized monomer therein. Each of these Example 5, 6, 7 passed heat stability.

### Comparative Examples 5, 6, and 7

These additional Examples were prepared according to the procedure of Comparative Example 1. Comparative Example 5 was made with the same composition as in Comparative Example 1, but with methyl methacrylate replacing styrene in Latex 1 as a polymerized monomer therein. Comparative Example 6 was made with the same composition as Comparative Example 1, but changing the volume average particle size of Latex 1 to 140 nm by increasing the amount of Encor® 9710 seed to 15.7 parts and Dowfax® 2Al to 45.2 parts. Comparative Example 7 was made with the same composition as in Comparative Example 1, but with 2-acrylamido-2-methylpropane sulfonic acid replacing acrylamide in Latex 1 as a polymerized monomer therein. Each of these Comparative Examples 5, 6, and 7 failed the heat aging test as evidenced by the occurrence of undesirable viscosity increase, phase separation, and/or destabilization.

### Comparative Examples 8

Comparative Example 8 was made with the same composition as in Example 1, but without acrylamide in Latex 1 as a polymerized monomer therein. Comparative Example 8 failed the heat aging test.

The latex-silicate-siliconate composition of the current invention can be used as a one-part binder with high storage stability to prepare clear primers or sealers. The resulting coatings can be applied on, e.g., concrete substrates lacking substantial or any special surface preparation and achieve suitable adhesion. The composition may be used as primer or a sealer on inorganic substrates (e.g., cementitious and masonry substrates), in particular on concrete substrates. The primer, when used as a basecoat, allows the topcoat paints to have suitable adhesion on these substrates.

Thus, the present invention provides, e.g., compositions including binder a) and one-part coating compositions including binder a) as well as silicate and a siliconate that exhibit adhesion to inorganic substrates, especially masonry/cementitious substrates such as concrete substrates and in particular, for flooring, ceilings, and concrete surface applications. The coating compositions may further optionally comprise surfactant, rheology modifiers, defoamers, and other additives for primer and sealer applications.

In some embodiments, the invention herein can be construed as excluding any element or process that does not materially affect the basic and novel characteristics of the composition or process. Additionally, in some embodiments, the invention can be construed as excluding any element or process not specified herein.

Although the invention is illustrated and described herein with reference to specific embodiments, the invention is not intended to be limited to the details shown. Rather, various modifications may be made in the details within the scope and range of equivalents of the claims and without departing from the invention.

1. A one-part aqueous composition comprising by wt % of total weight of the composition:
a) 5-70 wt % of at least one emulsified polymeric binder, the binder comprising one or more of (meth)acrylamide or derivatives thereof as a polymerized monomer;
b) 1-55 wt % of at least one silicate;
c) 0.01-10 wt % of at least one alkyl siliconate;
d) water; and
e) optional additives;
wherein the binder is in a form of emulsified polymeric particles having a volume average particle size of 50 nm-500 nm.

2. A one-part aqueous composition comprising:
a) 50-94.9 wt % of at least one emulsified polymeric binder, the binder comprising (meth)acrylamide or derivatives thereof as a polymerized monomer; and
b) 5-50 wt % of at least one silicate; and
c) 0.1-10 wt % of at least one alkyl siliconate;
d) water; and
e) optional additives;
wherein the weight percent of a), b), and c) are based on a total dry weight of a)+b)+c), and
wherein the binder is in the form of emulsified polymeric particles having a volume average particle size of 50 nm-500 nm.

3. The one-part aqueous composition of claim 1, wherein the composition includes no more than 0.5 wt % of each of one or more intentionally added viscosity stabilizers, each of which comprises an amine.

4. The one-part aqueous composition of claim 1, wherein the at least one silicate b) comprises at least one of inorganic silicate salts, sodium silicate, potassium silicate, lithium silicate, rubidium silicate, ammonium silicate, orthosilicates, or a mixture thereof.

5. The one-part aqueous composition of claim 1, wherein the at least one alkyl siliconate c) conforms to Formula (I): 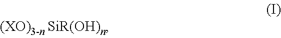
wherein X is an alkali metal; n is 0, 1, or 2; and R is an alkyl or aryl group.

6. The one-part aqueous composition of claim 5, wherein X comprises at least one of sodium, potassium, lithium, rubidium, cesium, or combinations thereof.

7. The one-part aqueous composition of claim 5, wherein R comprises a C1-C8 alkyl group or an aryl group.

8. The one-part aqueous composition of claim 5, wherein R comprises methyl, ethyl, n-propyl, iso-propyl, n-butyl, iso-butyl, tert-butyl, n-pentyl, iso-pentyl, tert-pentyl, neopentyl, phenyl, aryl, or cyclohexyl.

9. The one-part aqueous composition of claim 5 wherein R is methyl, X is potassium and n is 0.

10. The one-part aqueous composition of claim 1, wherein the binder a) further comprises, as polymerized monomers, at least one of styrene or derivatives thereof, alkyl (meth)acrylate, or (meth)acrylic acid.

11. The one-part aqueous composition of claim 1, wherein the binder a) comprises, as a polymerized monomer, from 0-90 wt % of styrene or derivatives thereof of the dry weight of the binder a).

12. The one-part aqueous composition of claim 1, wherein the binder a) comprises, as a polymerized monomer, from 10-99.8 wt % of alkyl (meth)acrylate of the dry weight of the binder a).

13. The one-part aqueous composition of claim 1, wherein the binder a) comprises, as a polymerized monomer, from 0.1 to 10 wt % of (meth)acrylic acid of the dry weight of the binder a).

14. The one-part aqueous composition of claim 1, wherein the binder a) comprises, as a polymerized monomer, from 0.01 to 10 wt % of (meth)acrylamide or derivatives thereof of the dry weight of the binder a).

15. The one-part aqueous composition of claim 1, wherein the binder a) further comprises, as a polymerized monomer, at least one crosslinkable co-monomer comprising two or more sites of ethylenic unsaturation.

16. The one-part aqueous composition of claim 1, further comprising at least one separate crosslinking agent, and wherein the binder a) further comprises, as a polymerized monomer, at least one crosslinkable co-monomer comprising an ethylenic unsaturation and at least one moiety capable of reacting with the separate crosslinking agent.

17. The one-part aqueous composition of claim 1, wherein the binder a) further comprises, as a polymerized monomer, at least one monomer selected from the group consisting of vinyl monomer, mono-ethylenically unsaturated carboxylic acid monomer, phosphorous containing monomer, sulfur containing monomer, silane-comonomers, and mixtures thereof.

18. The one-part aqueous composition of claim 1, further comprising at least one additive which is not a stabilizer selected from the group consisting of, amine compounds having a weight-average molecular weight in the range of 120 and 10,000, and organic quaternary ammonium compounds having a weight-average molecular weight in the range of 120 and 10,000.

19. A primer or sealer comprising the one-part composition of claim 1, and at least 5 wt % of additional water.

20. A coated substrate, comprising the one-part aqueous composition of claim 1 as a dried layer on at least one surface of the substrate, wherein the substrate is at least one of concrete, cement, asphalt, masonry, metals, alloys of metals, metalloids, ceramic, porcelain, granite, silica, or combinations thereof.
